(19) United States
(12) Patent Application Publication
(10) Pub. No.: US 2011/0214411 A1
(43) Pub. Date: Sep. 8, 2011

(54) DEVICE FOR THE PURIFICATION OF EXHAUST GASES AND MOTOR VEHICLE HAVING THE DEVICE

(75) Inventors: Wolfgang Maus, Bergisch Gladbach (DE); Stefan Seeliger, Alterstedt (DE)

(73) Assignee: EMITEC GESELLSCHAFT FUER EMISSIONSTECHNOLOGIE MBH, Lohmar (DE)

(21) Appl. No.: 13/070,828

(22) Filed: Mar. 24, 2011

Related U.S. Application Data
(63) Continuation of application No. PCT/EP2009/062079, filed on Sep. 17, 2009.

(30) Foreign Application Priority Data
Sep. 24, 2008 (DE) 10 2008 048 805.4

(51) Int. Cl. F01N 3/00; B01D 46/42

(52) U.S. Cl. 60/272; 55/385.3

(57) ABSTRACT

A device for the purification of exhaust gases in an exhaust gas system of an internal combustion engine includes at least one exhaust gas purification component through which exhaust gas can flow. The exhaust gas purification component is disposed in an outer pipe formed of titanium or a titanium alloy and, in particular, all structural components of the device are formed of titanium or a titanium alloy. A motor vehicle having the device is also provided.

### CROSS-REFERENCE TO RELATED APPLICATION

This is a continuation, under 35 U.S.C. §120, of copending International Application No. PCT/EP2009/062079, filed Sep. 17, 2009, which designated the United States; this application also claims the priority, under 35 U.S.C. §119, of German Patent Application DE 10 2008 048 805.4, filed Sep. 24, 2008; the prior applications are herewith incorporated by reference in their entirety.

### BACKGROUND OF THE INVENTION

### Field of the Invention

The present invention relates to a device for the cleaning or purification of exhaust gases in an exhaust system, in particular in an exhaust system of an internal combustion engine in a motor vehicle. Such a device includes at least one exhaust-gas purification component which is disposed in an outer pipe and through which exhaust gas can flow. The invention also relates to a motor vehicle having the device.

In order to purify exhaust gases of mobile internal combustion engines (spark-ignition engines, diesel engines, etc.), the exhaust gas which is produced in the internal combustion engine is discharged through an exhaust system including exhaust lines, exhaust sections, etc, into the atmosphere. The exhaust gas is brought, in that case, into contact with at least one exhaust-gas purification component in order to convert or retain pollutants in the exhaust gas. Such exhaust-gas purification components are, for example, catalyst carrier bodies, adsorbers, particle traps, soot filters, flow distributors, flow mixers, heaters, etc. The integration of such exhaust-gas purification components into the exhaust section or the exhaust line itself poses particular demands due to the thermal and dynamic loading encountered in the exhaust system. It is necessary for the exhaust system as a whole, and in particular the exhaust-gas purification components, to have high mechanical strength even at high temperatures, to have high corrosion resistance with respect to the exhaust gases, and to be heat-resistant.

The known exhaust systems in motor vehicles are constructed at least primarily with regard to the effectiveness of the exhaust-gas purification components and generally a multiplicity of different exhaust-gas purification components in diverse configurations is proposed for that purpose. That has the result, however, that there is a conflict between the effectiveness and the weight of the exhaust system.

### SUMMARY OF THE INVENTION

It is accordingly an object of the invention to provide a device for the purification of exhaust gases and a motor vehicle having the device, which overcome the hereinafore-mentioned disadvantages and at least partially solve the highlighted problems of the heretofore-known devices and vehicles of this general type and which provide an exhaust system that meets the above-mentioned requirements and consequently has high mechanical strength, is corrosion-resistant and heat-resistant, and has a low mass.

With the foregoing and other objects in view there is provided, in accordance with the invention, a device for the purification of exhaust gases in an exhaust system of an internal combustion engine. The device comprises an outer pipe and at least one exhaust-gas purification component through which exhaust gas can flow. The at least one exhaust-gas purification component is disposed in the outer pipe and at least the outer pipe is composed of titanium or a titanium alloy.

The expression “exhaust-gas purification component” has been selected as a generic term for all known components for converting or removing pollutants contained in the exhaust gas. These are, in particular, catalyst carrier bodies, adsorbers, particle traps, soot filters, heaters, flow mixers, etc. The exhaust-gas purification components conventionally have an outer pipe which at least partially surrounds a functional body in order to provide the latter with a permanent outer form or to permit fixing of the elements disposed in the interior of the outer pipe. The shape of the outer pipe is conventionally cylindrical, although it may also have other shapes such as for example oval, polygonal, etc. The outer pipe is generally at least partially directly and/or materially connected to a honeycomb body which is disposed in the interior of the outer pipe and which is constructed in particular with structured and/or smooth foils. In this case, the outer pipe also forms, over a significant extent of the circumference, an inner surface impinged on by the hot exhaust gas, and is respectively in heat-conducting contact with the honeycomb body. It is also the case, in particular, that the exhaust-gas purification components are connected or fixed through the use of the outer pipe to the exhaust system or the exhaust-gas-conducting pipelines. In this case, the outer pipe may be fixed directly between two pipeline connecting pieces (end-side fixing) and/or may be at least partially accommodated in such a pipeline (fixing through the circumferential or peripheral surface). The fixing of the outer pipe to and/or in a pipeline preferably takes place through the use of a materially joined connection, such as for example a welded connection.

As a result of at least the outer pipe being formed from titanium or a titanium alloy, which has a high strength, is resistant to expansion and corrosion and has a low density, it is possible for the mass of the exhaust system to be further reduced in relation to an embodiment composed of steel, as a result of which the total mass of the vehicle is also reduced, and lower fuel consumption can be attained.

In this case, a “titanium alloy” is to be understood to be a material which forms the outer pipe and which has a predominant (weight) proportion of titanium. It is possible, if appropriate, for additives such as aluminum, chromium, iron or molybdenum to be added and it is preferable for the titanium proportion to be greater than the proportions of all of the additives. Titanium alloys which have these properties are known and have heretofore been used in particular in aircraft construction. There are different alloys with different properties, some of which have the properties required in the present case in their entirety or in part to a particular extent, in such a way that it is possible for the individual exhaust-gas purification components or their parts to be produced from different titanium alloys which are best suited to the respective situation.

Through the use of the invention, the following advantages, in particular, can be attained: titanium, with a density of approximately 4.5 g/cm³, has a specific weight advantage of 40% over steel materials, that is to say parts can be formed with a considerably reduced weight. The mechanical loadings of the parts and components by oscillations and vibrations originating from the engine are reduced due to the lower weight of the parts. Due to its tensile strength of up to 1290 N/mm², the titanium material has a strength similar to that of steel materials. Furthermore (as will be explained in detail below), the titanium material can also be provided so as to be highly resistant to corrosive media or environments. Finally, it should also be noted that the mechanical loading of the components as a result of thermal expansion is considerably reduced in the case of titanium materials due to the coefficient of thermal expansion being approximately 50% lower than that of high-grade steel.

In accordance with another feature of the invention, the outer pipe has a multi-layer construction and at least one of the layers is composed of titanium or a titanium alloy. In this case, it is possible in particular for the outer pipe to have a construction in which the layers are assigned different functions, and consequently the properties of the material of the layer can be adapted according to requirements. It is thus possible, for example, for temperature-resistant and/or more corrosion-resistant titanium/titanium alloy materials to be used radially at the inside, and for titanium/titanium alloy materials which can be better connected to the exhaust system to be used radially at the outside. In this case, it is nevertheless possible to maintain relatively thin wall thicknesses, in such a way that the aim of saving weight can nevertheless be achieved. It would also be possible, if appropriate, for a (thin) layer to be integrated which does not have titanium as the predominant constituent—for example for the purpose of heat insulation and/or heat dissipation.

Accordingly, a combination of components composed of the high-grade steel material which is conventional in the exhaust-gas field with a component composed of titanium material, is also conceivable. It would thus be possible for a high-temperature-resistant high-grade steel element to be mounted in the interior of an outer pipe produced from titanium material. For this purpose, force-locking and/or form-locking joining techniques, as well as cohesive connections of the material combination through the use of corresponding methods, such as for example brazing, may likewise be used. Titanium-based brazing materials in particular are proposed for this purpose. A force-locking connection is one which connects two elements together by force external to the elements, as opposed to a form-locking connection which is provided by the shapes of the elements themselves.

In accordance with a further feature of the invention, the exhaust-gas purification component has foils which are disposed in layers, which are structured in a corrugated manner at least in partial regions and form the walls of a multiplicity of channels through which the exhaust gases can flow and in which the foils are composed of titanium or a titanium alloy.

In accordance with an added feature of the invention, the same preferably also applies to smooth foils disposed between the corrugated structured foils. The smooth foils may likewise be composed of a titanium alloy.

In accordance with an additional feature of the invention, all of the structural components of the device are formed with titanium or a titanium alloy. This also includes, if appropriate, wire nonwovens, reinforcement structures, support pins, mixer structures, etc. This, of course, generally does not include coatings, channel closure connecting pieces, sensors, etc.

In accordance with yet another feature of the invention, the individual constituent parts of the device having the exhaust-gas purification components through which the exhaust gas can flow, in particular the (multi-layer) outer pipe, the corrugated structured foils and the smooth foils, may advantageously be composed of the same or different titanium alloys which are adapted to the respective element corresponding to its particular properties. It is preferable for the outer pipe to be composed of a different titanium material than the corrugated structured foils and/or the smooth foils.

In accordance with yet a further feature of the invention, it may, if appropriate, be advantageous for the titanium component to be provided with an outer protective coating. An “outer protective coating” is to be understood in particular to mean a coating which is provided on the (if appropriate entire) surface of the component and which is (in particular directly and proximately) connected to the component. It is, for example, possible for the titanium material to be provided with an aluminum coating (for example by plating), and for an intermetallic phase, and a homogenous aluminum oxide coating, to be formed as a result of a subsequent heat treatment. In order to obtain minimal coupling of heat into the titanium material matrix, a laser is preferably used as a heat source. Alternatively or in addition, the titanium material may also be coated with a (different) ceramic protective coating. In this way, it is in particular also possible to meet the demand for a close-coupled configuration and/or temperature loading of up to 1200° C. The high-temperature oxidation resistance and high-temperature strength are thus considerably improved in this way, while the cold workability is maintained.

In accordance with yet an added feature of the invention, a titanium alloy is provided which has at least one of the following alloy elements: aluminum, niobium, silicon, zirconium. It is preferable for at least three of the alloy elements to be provided, in particular even all of them together. The following ranges are specified as an example of suitable titanium alloys in this context:

aluminum: from 16 to 35% by weight;
niobium: from 0.3 to 22% by weight;
silicon: from 0.05 to 1.4% by weight; and
zirconium: from 0.1 to 4.7% by weight.

In this case, it is also preferable for the titanium proportion in the titanium alloy to be greater than 40% by weight or even greater than 50% by weight, and very particularly preferably at least 80% by weight. If appropriate, silicon and zirconium may be provided alternatively.

With the objects of the invention in view, there is concomitantly provided a motor vehicle, comprising a diesel internal combustion engine, an exhaust system and at least one device according to the invention disposed in the exhaust system.

Other features which are considered as characteristic for the invention are set forth in the appended claims, noting that the features specified individually in the dependent claims may be combined with one another in any desired technologically meaningful way and define further embodiments of the invention.

Although the invention is illustrated and described herein as embodied in a device for the purification of exhaust gases and a motor vehicle having the device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, plan view of an exhaust system of an internal combustion engine in a motor vehicle; and

FIG. 2 is a cross-sectional view of a structural variant of the device according to the invention.

### DETAILED DESCRIPTION OF THE INVENTION

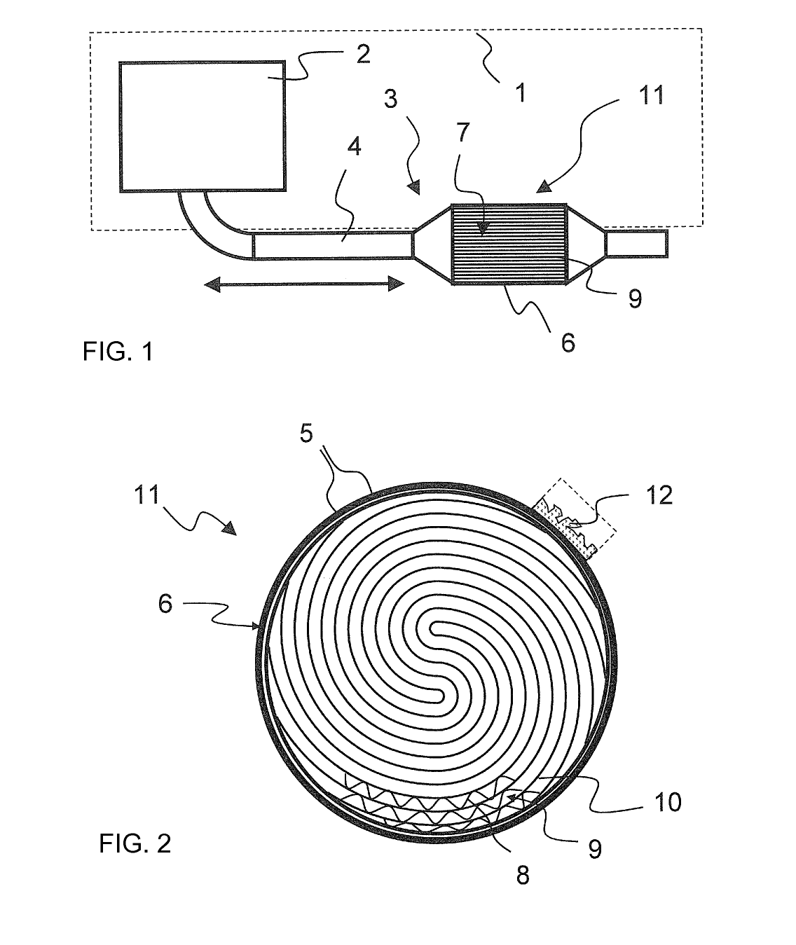

Referring now in detail to the figures of the drawing for explaining the invention and the technical field in more detail by showing particularly preferred structural variants to which the invention is not restricted, and first, particularly, to FIG. 1 thereof, there is seen a motor vehicle 1, which is symbolically illustrated by a rectangle in dashed lines and is provided with an internal combustion engine 2, for example in the form of a diesel engine. Exhaust gases from the internal combustion engine 2 are conducted through an exhaust system 3 which has a pipeline 4 and a conically widened portion adjoining the pipeline 4. The conically widened portion has a device 11 according to the invention including an outer pipe or casing 6 and an exhaust-gas purification component 7. The exhaust-gas purification component 7 may be a catalytic converter body, an adsorber, a particle trap, a soot filter, a heater, a flow mixer, etc. Further units and apparatuses may, of course, also be integrated in the exhaust system 3 for treating the exhaust gases.

The outer pipe 6 of the device 11 encompasses the exhaust-gas purification component 7, which is formed in the manner of a honeycomb body having a plurality of channels 9. The exhaust-gas purification component is constructed with a plurality of smooth foils 10 and foils 8 which are structured in a corrugated manner at least in partial regions, and disposed in layers. As can be seen from FIG. 2, the foils are wound, for example, in an S-shape to form a honeycomb body and are disposed in the outer pipe 6.

The outer pipe 6 and/or the corrugated structured foils 8 and/or the smooth foils 10, preferably all of the parts, are composed of one or more titanium materials or titanium alloys. If only a single titanium alloy is selected for all of the elements, the titanium alloy must represent a sensible compromise between requirements, that is to say it must have adequate dimensional rigidity and oxidation and corrosion resistance. If different titanium alloys are selected for the individual parts, they may be adapted to different usage conditions. It is thus possible for a titanium alloy which is resistant to higher temperatures and resistant to oxidation and corrosion to be selected for the exhaust-gas purification component 7 with the foils 8, 10, while a titanium alloy with relatively high mechanical strength can be selected for the outer pipe 6.

It is particularly preferable for the device according to the invention to be used in exhaust systems of diesel engines. Since diesel engines are heavier than spark-ignition engines for a given power output, that increased weight can be at least partially compensated for through the use of an exhaust system composed of a titanium alloy, which has a lower specific weight than a steel alloy. Furthermore, the exhaust gases of diesel engines have a lower temperature, even at full load, than the exhaust gases of a spark-ignition engine, so that the demands on the device with regard to heat resistance are lower. In the case of spark-ignition engines, it is necessary, if appropriate, for a distance (indicated by a double arrow in FIG. 1) from the engine to the device to be selected to be adequately large.

FIG. 2 shows a device 11 which is constructed in the form of a catalyst carrier body and which has an outer pipe 6 that is formed with two layers 5. The layers 5 are in contact with one another over their entire circumference but may, for example, be formed from different titanium materials. It is likewise possible for the layers 5 to be formed with different wall thicknesses, although this is not imperatively necessary. It is also possible to provide a greater number of layers 5, in which generally no more than three layers should be used in order to comply with the demand for saving weight.

FIG. 2 likewise shows an alternative provision of an outer protective coating 12 on the surface of the outer pipe 6 or of the layer 5 in an enlarged section (which is not to scale). The outer protective coating 12 is, in particular, a coating which includes aluminum. The outer protective coating 12 may nevertheless also be provided at other locations or all locations of the device 11, in particular on all of the surfaces impinged upon by exhaust gas.

The present invention is not restricted to the illustrated exemplary embodiments. Numerous modifications of the invention are in fact possible within the scope of the claims.

1. A device for the purification of exhaust gases in an exhaust system of an internal combustion engine, the device comprising:
an outer pipe; and
at least one exhaust-gas purification component through which exhaust gas can flow, said at least one exhaust-gas purification component being disposed in said outer pipe;
at least said outer pipe being composed of titanium or a titanium alloy.

2. The device according to claim 1, wherein said outer pipe has a multi-layer construction including at least one layer composed of titanium or a titanium alloy.

3. The device according to claim 1, wherein:
said exhaust-gas purification component has foils disposed in layers, structured in a corrugated manner at least in partial regions and forming walls of a multiplicity of channels through which the exhaust gases can flow; and
said foils are composed of titanium or a titanium alloy.

4. The device according to claim 3, which further comprises smooth foils each disposed between a respective two of said corrugated structured foils, said smooth foils being composed of titanium or a titanium alloy.

5. The device according to claim 4, wherein said outer pipe is composed of a different titanium material than at least one of said corrugated structured foils or said smooth foils.

6. The device according to claim 4, which further comprises an outer protective coating disposed on said titanium outer pipe, corrugated structured foils and smooth foils.

7. The device according to claim 4, wherein said titanium alloy has at least one of the following alloy elements: aluminum, niobium, silicon, zirconium.

8. A motor vehicle, comprising:
a diesel internal combustion engine;
an exhaust system connected to said engine; and
at least one device according to claim 1 disposed in said exhaust system.
